(19) United States
(12) Patent Application Publication
(10) Pub. No.: US 2015/0189219 A1
(43) Pub. Date: Jul. 2, 2015

(54) REAL-TIME AUTOMATIC MUTE CONTROL SYSTEM

(71) Applicant: RAGHU Ram KOPALLE, Albuquerque, NM (US)

(72) Inventor: RAGHU Ram KOPALLE, Albuquerque, NM (US)

(21) Appl. No.: 14/143,234

(22) Filed: Dec. 30, 2013

(51) Int. Cl. H04N 5/60; H04N 5/44

(52) U.S. Cl. CPC H04N 5/60; H04N 5/4403

(57) ABSTRACT

An automatic advertisement muting control device incorporating a processor for processing the program source to detect the presence of commercial messages. Video and audio event detectors detect the presence of events in the signal as it is received in real-time. The timing relationship of the detected event is analyzed to classify the video segments between events as program material or as commercial messages. The control device is designed to mute the signal automatically and in real-time during commercials until the commercial finishes; a remote control, where the remote control enables a user to manually operate the control device by sending a set of signals.

### BACKGROUND OF THE INVENTION

1. Field of the Invention

The present invention relates to a device that automatically in real-time mutes the audio and/or video output of a program source during the broadcasting of commercial messages and then automatically “un-mutes” the signals once the commercial is finished.

2. Description of Prior Art

The television has become a ubiquitous entertainment and information appliance of the home and it is rare to find a home today that does not have at least one television set. With this wide audience available to broadcast companies and the attendant advertising revenue source, the use of commercial advertisement messages during the broadcasting of program material is increasing every day. A substantial portion of the entertainment program material is being preempted by commercial messages for advertising purposes. While the interruption of such program material for commercial material messages has always been somewhat disturbing to the viewing audience, the increase in preemption of time of the program material for advertising is beginning to bring about a strong adverse reaction by the viewing audience especially when the same advertisement is repeated several times within the space of a single program. Very little has been done in the past to eliminate the disturbing aspects of commercial messages in television broadcasting since, to the broadcasting network, such a reduction in commercial messages would be accompanied by a loss of advertising revenue. On the other hand, the television viewer with a typical lack of skill in electronic matters can do very little to reduce the nuisance aspects of television advertising broadcasting. The only recourses left for the typical television viewer are a) record the programming and skip the advertisements manually, if they have access to a recording device such as a DVR or b) Manually turn off the TV set or amplifier set connected to the speakers or turn down the audio by some type of remote control device. Such approaches are highly inconvenient, their practice often error prone and dissatisfactory.

Various techniques are known for monitoring transmissions from signal sources such as a broadcast from a television station, a radio station, a satellite provider, cable provider or terrestrial station. In addition, recording and playback devices such as DVD/Blu-ray disc players, VCRs, Cable/satellite/Terrestrial/IPTV Set top boxes, DVRs or similar audio/video equipment are available. Hereafter, we will refer to all such sources as “program source”. The signal of interest might be a program being transmitted by terrestrial, cable, satellite or the Internet/IP, or it might be a recorded program being played back on a DVD, VCR or similar audio/video equipment. The program of interest may be of any content genres—movies, news, music, TV shows, documentaries, information channels or it might be a commercial or combinations of genre-based content and commercials. Commercial advertisements are closely intertwined with user desired content. Several techniques on separating user desired content from commercials exist but very few commercially available devices exist that allow users to control the audio/video output of the program content and commercials.

A prior art, a US patent application publication US20120169938, which leaves the implementation details to the imagination of the designer and vaguely refers to having to be “configured”, describes an idea of a device that send control signals to mute the television but requires “re-configuration” whenever a different television is used, thereby limiting its ease of use to the average home user. This application is seeking to patent an idea.

A prior art, a U.S. Pat. No. 4,259,689, a system applicable only to CRT based television sets and requiring implementation by the manufacturer.

A prior art, a U.S. Pat. No. 6,404,977, a system that is aimed at embedding the feature customized inside a VCR and assumes that advertisements are broadcast only in segments of 15 seconds, 30 seconds or 60 seconds, requiring the manufacturer to implement the feature.

A prior art, a U.S. Pat. No. 4,739,398 A, outlines complex methods of pattern analysis using expert systems and is aimed at embedding the feature customized inside a television or inside a recording/playback device, which are of many types, sizes and shapes also requiring the manufacturer to implement the feature.

These prior arts do not propose a universal solution that works independently with the TV broadcasting deployments and is dependent on the manufacturer of the televisions and recording/playback equipment to implement it, limiting its availability to the consumer.

### SUMMARY OF THE INVENTION

The present invention provides a set of hardware devices and software mechanisms for automatically controlling the audio and/or video output of a program source during the broadcasting of commercial messages.

It is therefore the primary object of this invention to provide a novel, easy-to-use automatic advertising muting system that responds immediately to the presentation of a commercial message in the program to mute audio and/or video output of the program source during the commercial message.

It is another object of the present invention is to provide a remote control that manually overrides the automatic features of the device to provide continuous control to the viewer.

It is a further object of the present invention to provide a new and novel television advertising muting system which may be easily attached between any commercially available program source and the television for discontinuing the audio video output of the program during commercial messages, which is simple and inexpensive in construction and which utilizes a minimum of readily available commercial parts to instantaneously and without fail respond to the beginning of one or more commercial messages to remove the audio video output from the program source.

It is still a further object of the present invention to provide a new and novel television advertising muting system in which the audio and the video signal in the program is utilized to interrupt the audio video output from the program source during a commercial message and which may be applied easily, independent of the program source and the television.

It is still another object of the present invention to provide a new and novel television advertising muting system that can be implemented as a software application that is downloadable on any android/iOS/Windows Mobile/Windows/Linux based set top box or IPTV streaming media device or computing device and which may be applied easily, independent of the program source and the television.

In lieu of the foregoing disadvantages inherent in the prior art, the objects of the invention and related objects are accomplished in a novel device that provides real-time monitoring of a program source and provides an automatic mute control, comprising the device incorporating a processor for processing the program source to detect the presence of commercial messages, attached to the program source and the corresponding viewing audio/video equipment. Video and audio event detectors detect the presence of events in the signal as it is received in real-time. The control device is designed to mute the signal automatically and in real-time during commercials until the commercial finishes; a remote control, where the remote control enables a user to manually operate the control device by sending a set of signals.

The objects stated above and other related objects and advantages of the present invention will become apparent to those skilled in this art upon reading the accompanying description, drawings and claims set forth herein. The headings provided herein are for the convenience of the reader only. No headings should be construed to limiting upon the content in any way.

The unique feature of the present invention is that it is independent of the program source and the viewing audio/video equipment and requires no user configuration to work. This feature makes the device truly plug and play! Further device is a true consumer grade device in its cost as well.

### BRIEF DESCRIPTION OF THE DRAWINGS

Various embodiments of the invention are disclosed in the following detailed description and accompanying drawings.

FIG. 1 is a pictorial view showing the overall setup related to how the present invention is envisioned in use in a typical audio video entertainment setup.

FIG. 2 is a diagram showing one embodiment of the present invention where in only the analog audio component of the program source is used to implement the Device.

FIG. 3 is a diagram showing a second embodiment of the present invention where in both the analog audio and video components of the program source is used to implement the Device.

FIG. 4 is a diagram showing a third embodiment of the present invention where in only the digital audio component of the program source is used to implement the Device.

FIG. 5 is a diagram showing a fourth embodiment of the present invention where in the digital audio and video components of the program source in the form of the HDMI interface is used to implement the Device.

FIG. 6 is a diagram showing a sixth embodiment of the present invention where in any of the digital and analog audio and video components of the program source may be used to implement the Device permitting total flexibility to use any of the input/output combination in connecting between the program source and corresponding viewing audio video equipment.

FIG. 7 is a system diagram of the major building blocks incorporated in the present invention.

### DETAILED DESCRIPTION OF THE INVENTION

### 1. Definitions

“Program Source” is defined as any device or service that delivers a video signal, audio signal or a combination of both signals;

“Real-time” refers to live broadcast of video or audio data transmission or streaming data transmission or playback from a program source;

“DVD Player” is defined as a Digital Video Disc Player;

“Blu-ray Player” is defined as a Blu-ray disc format player;

“Set top box” is defined as a device that decodes encoded video/audio signals

“IP” Internet Protocol, the protocol that is the basis of the Internet;

“IPTV” Internet Protocol Television;

“Amplifier/Receiver” is defined as a device that integrates hardware connections in an entertainment system, amplifies or enhances NV signals and serves as a media center receiver, AM/FM transmitter;

“HDMI” is an abbreviation for High-Definition Multimedia Interface;

“Display Device” is defined as any device with a screen capable of displaying a video image;

“VCR” is defined as a Video Cassette Recorder;

“Android” is a mobile device operating system created by Google Inc.; “iOS” is a mobile device operating system created by Apple Inc.;

“Windows Mobile” is a mobile device operating system created by Microsoft Corporation;

“Windows” is a computing operating system created by Microsoft Corporation;

“Linux” is an open source computing operating system.

### 2. Best Mode of the Invention

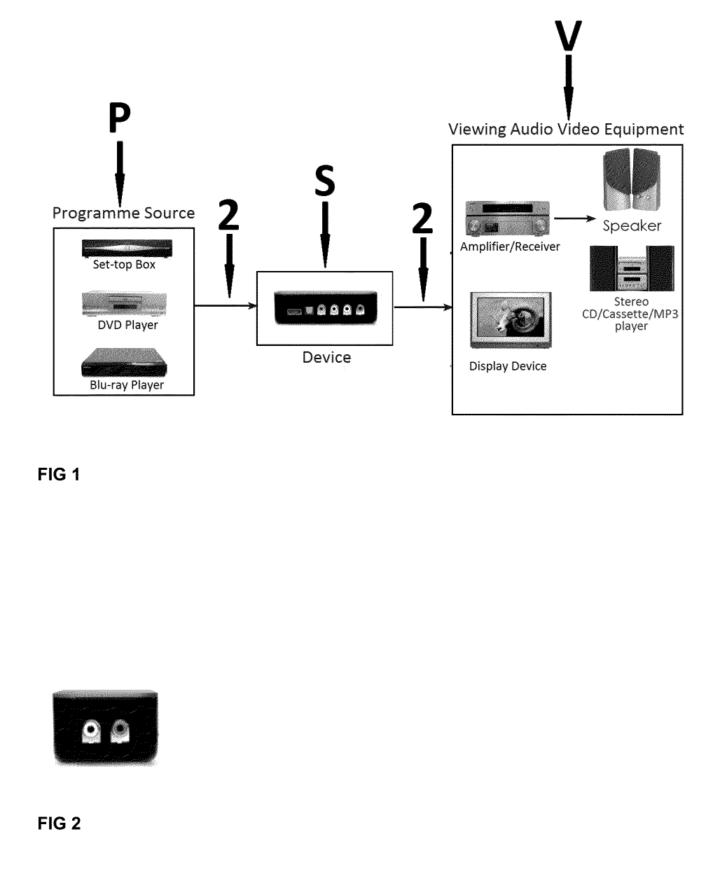

FIG. 1 demonstrates the best mode contemplated by the inventor. FIG. 1 also illustrates the preferred deployment of the present invention, marked S and called the device, connected between one or more Program Sources indicated by “P” and the corresponding viewing audio video equipment indicated by “V”. The connections marked “2” represents the actual cables such as Analog Audio, Digital Audio and/or HDMI cables connected between the corresponding input output points of the Program Source, the device and the viewing audio video

### 3. How to Make the Invention

FIG. 7 depicts the internal block diagram of the present invention. It comprises of an input block containing the input interfaces marked as 3, 4 & 5, an output block containing the output interfaces marked as 7, 8 & 9; and a processing block marked as 6.

It has been found that nearly every commercial message in broadcasting is preceded by a brief period when the audio video information goes dark, followed by the beginning of the commercial message. A second thing noted is that the audio level increases to a much higher level that when the regular program is broadcast. A third thing noted is that the audio becomes monaural. These three aspects are exploited individually or in combination to implement the present invention.

The input blocks 3, 4 & 5 provide the necessary mechanical and electrical interfaces to reliably connect to the program source. Similarly the output blocks 7, 8 & 9 provides the necessary mechanical and electrical interfaces to reliably connect to the viewing audio video equipment.

The processing block 6 continuously monitors the input signals and makes the same available without any alteration at its outputs. As part of the monitoring it analyzes the input signal to determine whether the three aspects as described above is present in the signal or not. Whenever such an event occurs the processing element alters the audio and/or video portion of the signal so that at the outputs the corresponding signal is at the black level. When the processing element detects the reverse of the three aspects described above, it once again sets it output to pass through without any modifications.

In an additional embodiment of the automatic mute control the detector circuit may be constructed or incorporated directly into the program source or the viewing audio/video equipment. In this embodiment a separate control device is not necessary. The detector circuit may be built within the program source or the viewing audio/video equipment at the manufacturing company therefore providing the automatic mute feature as an additional accessory feature of the equipment. The automatic mute feature may be incorporated into a range of program sources and audio/video entertainment equipment to provide a more enjoyable viewing experience for all viewers. This software implementation could be implemented in a variety of operating systems, including Android, iOS, Windows Mobile, Windows and MAC OS X.

In an additional embodiment the remote control can also be implemented in software as well, that can run on existing devices such as smartphones or tablets.

The disclosed embodiments are illustrative, not restrictive. While specific configurations of the technology have been described, it is understood that the present invention can be applied to a wide variety of technology categories. There are alternative ways of implementing the invention.

### 4. How to Use the Invention

Numerous specific details are set forth in this detailed description section in order to provide a thorough understanding of the invention.

The present invention relates to a device that in real-time automatically mutes the audio and/or video signals going through it to the viewing audio/video equipment when a commercial airs or plays and then automatically resumes the signals once the commercial is finished.

The present invention provides an automatic mute control that includes a control device that is programmed to detect commercials and mute audio and/or video signals, and a remote control to manually activate the control device.

The control device automatically detects commercials and the audio and/or video signal is temporarily disabled until the regular programming resumes.

The automatic mute control requires no codes or special programming, and does not require any changes even if the device is moved to different program source and audio video viewing equipment, making it a practical tool for enhancing any audio/video viewing experience.

### 5. Examples of the Invention

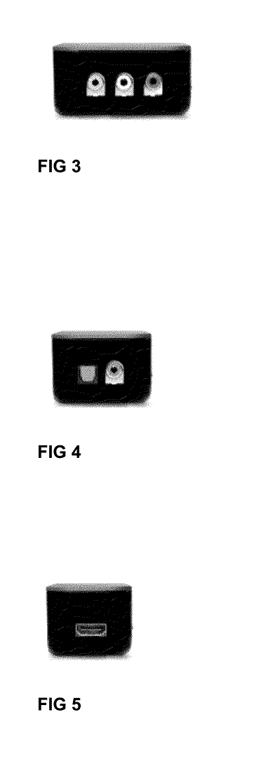

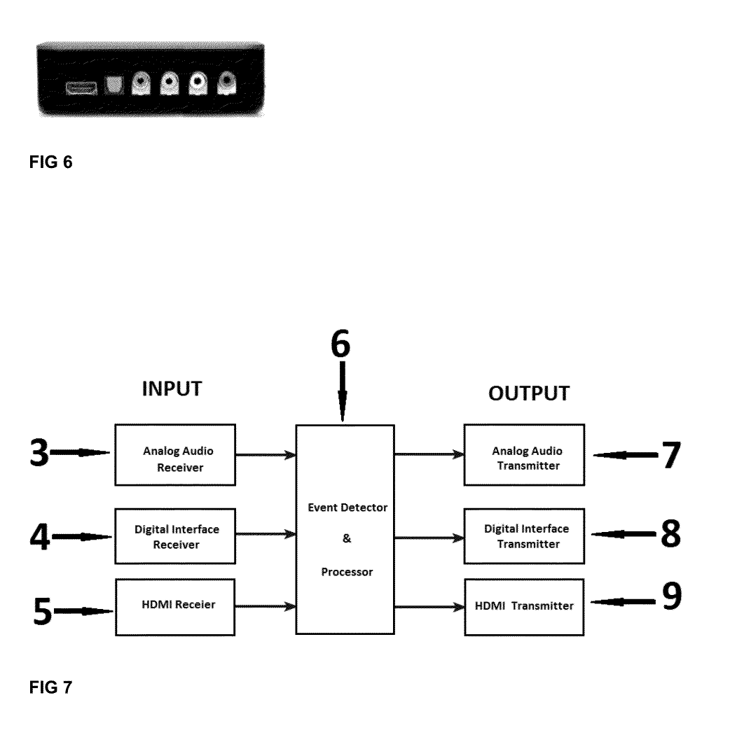

FIG. 1, FIG. 2, FIG. 3, FIG. 4, FIG. 5 and FIG. 6 are descriptions of specific embodiments of the present invention. These examples have been presented for purposes of illustration and description. They are not intended to be exhaustive or to limit the invention to the precise forms disclosed, and obviously many modifications and variations are possible in light of the above teaching.

The exemplary embodiment was chosen and described in order to best explain the principles of the invention and its practical application, to thereby enable others skilled in the art to best utilize the invention and various embodiments with various modifications as are suited to the particular use contemplated.

1. A real-time automatic mute control comprising:
a control device connected between a program source and the corresponding viewing audio/video equipment, where said control device is designed to selectively mute the audio/video signals going through it;
a signal window attached to a front portion of said control device, where said signal window receives a set of signals;
a remote control, where said remote control enables a user to manually operate said control device by sending said set of signals; and
a detector circuit housed within said control device, wherein said detector circuit recognizes when a commercial airs on said television thereby activating said control device to mute the audio/video signals going through it until said commercial finishes.

2. The automatic mute control according to claim 1, wherein said control device includes a set of indicator lights.

3. A method for identifying selected segment of a program source signal comprising the steps of:
(a) detecting a first event;
(b) analyzing the nature of the event;
(c) detecting the end of the event; and
(d) detecting the resumption of regular program

4. The automatic mute control according to claim 1, wherein said control device includes a remote control.

5. The automatic mute control according to claim 1, wherein said set of buttons activate said plurality of signals to operate said control device.

6. The automatic mute control of claim 1, implemented in software for Android operating system based devices

7. The automatic mute control of claim 1, implemented in software for Apple iOS operating system based devices

8. The automatic mute control of claim 1, implemented in software for Microsoft windows mobile operating system based devices

9. The automatic mute control of claim 1, implemented in software for Microsoft windows operating system based devices

10. The automatic mute control of claim 1, implemented in software for MAC OS X operating system based devices.

11. The automatic mute control of claim 1, implemented in software for Linux operating system based devices.

12. The automatic mute control according to claim 3, wherein said remote control includes a set of buttons.

13. A method for identifying segment of program signal according to claim 3, wherein the user can toggle muting program vs the commercial advertisements and only watch advertisements, if desired

14. A method for controlling the audio and video output from the program source.

15. The method of claim 14 wherein controlling the audio video from the program source to alter the signals to the viewing audio and video equipment comprising muting an audio portion of the said signal.

16. The method of claim 14 wherein the audio portion of the said signal is muted for a length of time in association with end of the commercial event.

17. The method of claim 14 wherein the video portion of the said signal is muted for a length of time in association with end of the commercial event

18. The method of claim 14 further comprising generating a visual alert in the control device during the length of time during which the audio portion of the said signal is muted.

19. The method of claim 14 wherein controlling the audio video from the program source to alter the signal sent to the viewing audio video equipment comprising muting a video portion of said signal.

20. The method of claim 14 wherein the video portion of the said signal is muted for a length of time in association with end of the commercial event.

21. The automatic mute control according to claim 14, wherein said set of indicator lights include a power indicator and an in-use indicator.

22. The automatic mute control according to Tim 14, wherein said power indicator notifies said user when said control device is on, and said in-use indicator notifies said user when said control device is muting the audio/video Thorn the program source.
